(19) United States
(12) Patent Application Publication
(10) Pub. No.: US 2024/0367311 A1
(43) Pub. Date: Nov. 7, 2024

(54) Mobile Printing Robot Printing Methods and Merging Items to Print

(71) Applicant: Dusty Robotics, Inc., Mountain View, CA (US)

(72) Inventors: Philipp Josef Herget, Sunnyvale, CA (US); Nickolas Rossi, San Mateo, CA (US)

(21) Appl. No.: 18/652,760

(22) Filed: May 1, 2024

Related U.S. Application Data
(60) Provisional application No. 63/499,435, filed on May 1, 2023.

(51) Int. Cl. B25J 5/00; B25J 9/16; B25J 11/00

(52) U.S. Cl. CPC B25J 5/007; B25J 9/1661; B25J 11/005

(57) ABSTRACT

A mobile printing robot combines items to print into a small number of print operation than the number of items. The physical constraints of the robotic printing system may be taken into account. A determination is made whether the printing system is capable of printing a layout in a reduced number of print operations.

### TECHNICAL FIELD

The present disclosure is related to mobile robot technology. More particularly, the present disclosure is related to mobile robots that can print markings on a horizontal surface.

### BACKGROUND

Mobile robots can be used for a variety of applications. One environment in which mobile robots could be used is a construction jobsite, where a mobile robot could perform a variety of functions in the environment. One such application is the printing of drawings, text, or other markings on a surface such as the concrete floor of a building under construction.

### SUMMARY

A mobile printing robot prints features on a construction surface, such as a horizontal surface of a construction site. The mobile robot may be used to print a layout, but more generally it may also print lines, symbols, letters, and numbers. The mobile robot may be designed to print a listing of lines for at least part of a building layout.

In one implementation, a method of combining items to print with a mobile robotic printing system into a single print operation, or into a smaller number of print operations than the number of items includes identifying a set of items to be printed on a surface at specific locations; determining a set of fixed or temporary physical constraints of the robotic printing system; combining items that the robotic printing system is capable of printing in fewer print operations than the number of items, based on the relative position and orientation of the items as well as the physical constraints of the robotic printing system; and submitting the results of the algorithm as a new set of instructions to the robotic printing system.

In one implementation, a method of printing a layout has a plurality of layout elements as a series of single swath images printed by a printing robot. The method includes identifying physical limitations of the printing robot, including the width of a printing swath and the limitations on the pathways in which the robot can travel while printing accurately; combining two or more layout elements into one or more images in a way that reduces the total number of printing swaths required to complete the layout; identifying one or more printing pathways that allow the robot to print each image as single swath in the correct location; and printing with the printing robot at least a portion of the image swaths while following the printing pathways.

In one implementation, the method of printing a layout with a plurality of layout elements as a series of single swath images printed by a printing robot has the printing pathways consist of straight lines at arbitrary angles.

In one implementation, the method of printing a layout with a plurality of layout elements as a series of single swath images printed by a mobile printing robot has at least one printing pathway that is approximately perpendicular to one other printing pathway.

In one implementation, the method of printing a layout has a plurality of layout elements as a series of single swath images printed by a printing robot has the printing pathways additionally include curved paths.

In one implementation, a method of printing a layout has a plurality of layout elements as a series of single swath images printed by a printing robot additionally comprises further reducing the total number of printing swaths by omitting portions of the layout elements to be printed, wherein the omitted portions are portions that can be inferred by a viewer of the printed layout.

In one implementation, the method of printing a layout has a plurality of layout elements as a series of single swath images printed by a printing robot has one or more annotations (arrows, symbols, labels, geometric patterns, etc.) are added to one or more of the images to provide visual indicators of omitted content.

In one implementation, the method of printing a layout has a plurality of layout elements as a series of single swath images printed by a printing robot includes identifying one or more printing pathways that allow more than one swath to be printed along a single pathway.

In one implementation, the method of printing a layout has a plurality of layout elements as a series of single swath images printed by a printing robot has more than one swath is printed by more than one printer.

In one implementation, the method of printing a layout has a plurality of layout elements as a series of single swath images printed by a printing robot has the more than one swath printed sequentially by moving the printhead to a new location to print the next swath.

### BRIEF DESCRIPTION OF THE DRAWINGS

FIG. 1 illustrates an embodiment of a mobile printing robot system.

FIG. 2 is a block diagram of a mobile robot in accordance with an implementation.

FIG. 3A is a block diagram of a computing system in accordance with an implementation.

FIG. 3B is a block diagram of components of line printing merging and selective line section omission engine in accordance with an implementation.

FIG. 4 illustrates how a print operation can print different lines within the width of a printhead in accordance with an implementation.

FIG. 5 illustrates how a print operation can print different lines and line segments within the width of a printhead in accordance with an implementation.

FIG. 6 illustrates how a print operation can print lines and text within the width of a printhead in accordance with an implementation.

FIG. 7 illustrates how curved lines and other features can be printed within the width of a printhead in accordance with an implementation.

FIG. 8 illustrates how a plan of a printing operation may include adjusting a position of the printhead via a movable stage to increase the number of different lines that are printed in a single printing pass in accordance with an implementation.

FIG. 9 illustrates how a plan of a printing operation may include adjusting a position of the printhead via a movable stage to increase the number of different lines and text than be printed in a single printing pass in accordance with an implementation.

FIG. 10 illustrates how a plan for a printing operation may utilize two printheads to print different lines in accordance with an implementation.

FIG. 11 illustrates how a plan for a printing operation may utilize two printheads to print different lines and text in accordance with an implementation.

FIG. 12 illustrates how a plan for a printing operation may utilize two printheads and a movable stage to print different lines and text in accordance with an implementation.

FIG. 13 illustrates how a plan for a printing operation may be performed as a set of swaths in accordance with an implementation.

FIG. 14 illustrates how a plan for a printing operation may be performed as a set of swaths with different printing directions in accordance with an implementation.

FIG. 15 illustrates how a plan for a printing operation may be performed as a set of swaths with different printing directions and with a movable stage in accordance with an implementation.

FIG. 16 illustrates how a plan for a printing operation may be performed as a set of swaths with two or more printheads in accordance with an implementation.

FIG. 17 illustrates selective omission of a portion of a line in accordance with an implementation.

FIG. 18 illustrates selective omission of a portion of lines printed in swaths in accordance with an implementation.

FIGS. 19-20 illustrate an example of printing a layout in accordance with an implementation.

FIG. 21 illustrates an example flowchart of a method in accordance with an implementation.

FIG. 22 illustrates an example flowchart of a method in accordance with an implementation.

### DETAILED DESCRIPTION

### Exemplary Mobile Printing Robot System

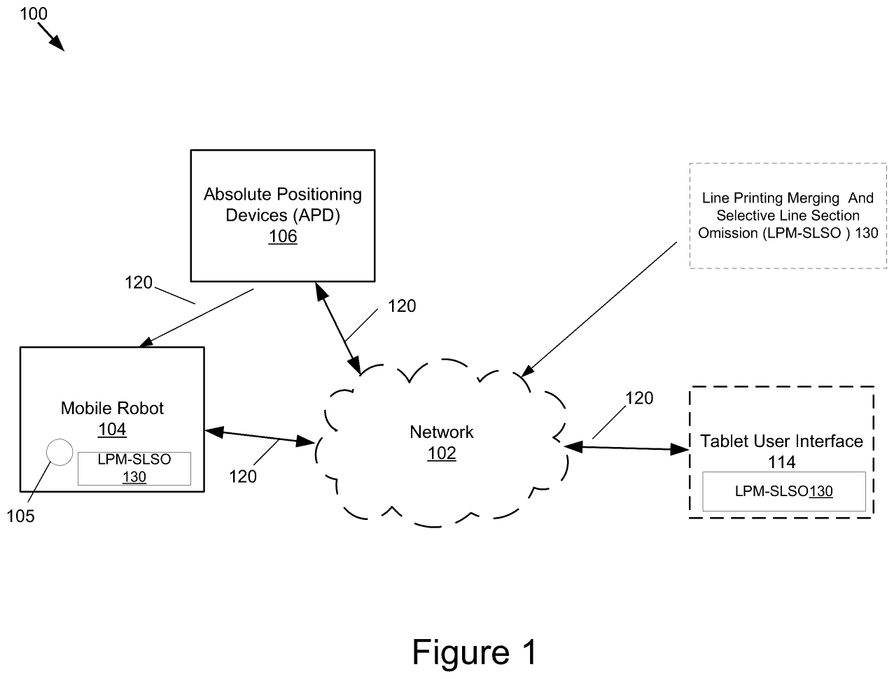

FIG. 1 illustrates a mobile robot printing system 100 that includes a mobile robot 104. The mobile robot 104 includes hardware and software to navigate around a construction site and print on a construction surface (e.g., a horizontal surface of a construction site, which for example, may be a concrete floor of a construction site).

One use of mobile robot 104 is to move around in a construction environment and print or otherwise form markings at specific locations. For example, a mobile robot 104 in one embodiment is a mobile printing robot that autonomously navigates and prints building layouts. For example, the mobile robot may print a building layout on a floor (e.g., a concrete surface) corresponding to an architect's plans for how a building is to be constructed. More generally, the mobile printing robot 104 may print other information on the floor besides a building layout.

In one embodiment, one or more absolute positioning devices (APD) 106 are provided that have a capability to accurately determine position/location. Some examples of APD approaches include a radio position measurement solution, such as those made by the Humatics Corporation. Other examples of APD approaches include optical position measurement solutions approach, such as the HTC Vive®. In one embodiment, the APD comprises a total station or laser tracker that measures the angles and distance from the APD 106 to a point on mobile robot 104. This information permits an accurate determination of the location of the mobile robot 104. As one example, the APD 106 may be a total station that measures angles and distance. A Total Station (TS) is a type of APD 106 comprising a laser rangefinder on an actuated two axis gimbal, which generates a laser beam that reflects off a reflective device such as a prism. A TS typically uses an electronic transit theodolite in conjunction with electronic distance meter (EDM). It is typically integrated with microprocessor, electronic data collector and storage system. It measures the sloping distance of object to the instrument, including horizontal angles and vertical angles. In one embodiment, the APD includes a laser tracker to track a reflector mounted on the mobile robot.

A TS or laser tracker measures both the distance to the reflector as well as two angles of the reflector relative to the base station. Using these three measurements, the location of the reflector can be calculated relative to the location of the TS. Thus, assuming a TS is positioned at a given location in the building, the reflector's position in the building can be determined with respect to the location of the TS.

For example, a total station may be mounted on a tripod at a selected height above a

construction surface. This then permits the total station to calculate horizontal and vertical angles to a point on the mobile robot 104, along with a distance measurement. From that information, an accurate determination of the absolute position of the mobile robot is calculated.

While a total station is one example of an APD, it will be understood that other optical or RF devices that determine angles or distance to a point on the mobile robot 104 may be used.

In one embodiment, the APD 106 measures the robot's location by using a laser, to detect the location of a reflector, prism, or similar retroreflective device 105, which can be affixed to the robot 104.

In one embodiment, a laser beam of the APD 106 transmits a laser beam that is directed in a line-of-sight path towards the retroreflective device 105.

In some embodiments, the APD 106 automatically tracks the movement of the mobile robot 104 such that it generates a series of position/location readings for the mobile robot 104.

The retroreflective device 105 may be any optical element or set of elements that reflects light back to its source over at least a certain range of angles, sometimes called a field of view, although there are other terms used in the optics art. In classical optics, a three-corner mirror having three faces is an example of a retroreflector. However, some prisms are retroreflective over a range of angles. There are also optical devices that have a set of facets that are retroreflective over a range of angles. There are also certain classes of retroreflective materials, such as certain retroreflective coatings. Some total stations also integrate with active reflectors having multiple sets of corner reflectors along with active electronics to prevent the total station from locking onto other reflective surfaces, such as safety vests. In some implementations, an active reflector is used in combination with the robot for accurate position measurements.

The retroreflective device 105 may be implemented as a 360-degree retroreflective device. Alternatively, it may have a narrower field of view but be rotated during use towards the APD to maintain a lock.

In some implementations, the measured location is communicated to the robot via a wireless communication network 120. There are many different ways that the measured location information may be communicated. However, a low-latency and low variable latency communication link is desirable. This is because there are various tradeoffs between the velocity of the mobile robot, the desired printing accuracy, and the effect of latency in the receipt of location information being useful to improving the accuracy of the printing of the mobile robot 104. For example, suppose the mobile robot 104 moves at a velocity of one m/s. That would, in turn, mean that a 1 ms communication delay would correspond to a 1 mm distance traveled by the mobile robot. If the objective was to achieve on the order of 1 mm printing line accuracy, then in this example the time delay in receiving the location information would be coming later in time than would be ideal for controlling the movement of the mobile robot 104. In some implementations, the controller of the mobile robot predicts a current location. For example, the mobile robot can handle long time in receiving location information by predicting its current location based on received instances of position data and associated timestamps.

The communication link 120 may use an existing network such as Wi-Fi™. However, Wi-Fi™ can be subject to large delays in some locations, such as in cities in which there is a lot of Wi-Fi™ communication near a construction site. LPWAN (Low Power Wide Area Network) communication protocols such as Sigfox and LoRa, or other low frequency wireless communication protocols are possibilities. LoRa uses spread spectrum techniques to minimize interference. A local direct optical link is another possibility, such as using a separate laser beam (or Light Emitting Diode) to communicate location information on a direct link. A direct local radio frequency link is another possibility. In any case, a variety of different network communication techniques or a direct communication channel using a radio or optical connection may be used as the communication link between the APD 106 and the robot 104.

In some embodiments, non-time sensitive information may be communicated using a different communication link. For example, a conventional wireless link, such as a Wi-Fi™M network link may be used to communicate non-time sensitive information.

In one embodiment, an optional portable computing device having a user interface 114, such as a tablet computing device having a user interface 114, may communicate with the mobile robot 104. In some embodiments, the optional portable device may also be in communication with the APD 106.

In one embodiment, a user or operator of the mobile robot 104 uses the user interface 114 of the portable device to access information related to the status of the mobile robot 104, access building information of a building information model (BIM) or CAD model or enter commands to the mobile robot.

The BIM or CAD model generally contains all information about the building including the line segments providing the outline of the walls to be built and the walls that are already existing in the site. This BIM or CAD can be used to generate a map on which the robot navigates and may contain a set of obstacles that the robot expects to encounter when drawing the wall outlines onto the floor.

Also, as construction proceeds, there may be a variety of obstacles present on the construction site that cannot be generated from the BIM. This can include obstacles to the safe movement of the mobile robot, such as pallets left on the construction site. But it may also include other aspects of the construction, such as piping, wiring, etc.

The presence of obstacles may also prevent the use of an APD 106 requiring a direct line-of-sight. For example, if the mobile robot 104 moves behind a post, a pallet left on the construction site, or a wall, then an APD based on a line-of-sight may become temporarily ineffective.

As discussed below in more detail, a Line Printing Merging And Selective Line Section Omission (LPM-SLSO) 130 engine optimizes the printing of lines of a layout.

The LPPO 130 engine may be implemented in different ways, such as a web-based or cloud-based implementation, on a local computing device 114 (e.g., a tablet device) or on the mobile robot 104.

### General Robot Example

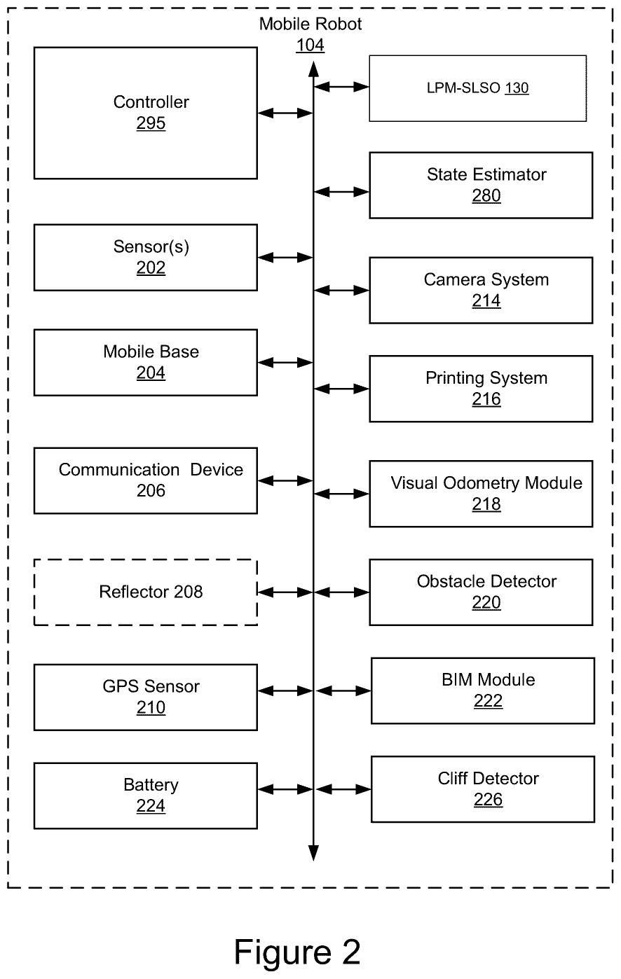

FIG. 2 shows a general mobile robot system as an example. As shown in FIG. 2, one implementation of the mobile robot 104 comprises a controller 295; one or more sensors 202, one of which may be an IMU, accelerometer, gyroscope, or compass; a mobile base 204 including features, such as motors and wheels to move the mobile robot; a communication device 206; a reflector 208, a GPS sensor 210, a battery 224, a cliff detector 226, a BIM module 222 to access BIM or CAD data, an obstacle detector 220 (which may include a depth camera or a lidar), a visual odometry module 218, a printing system 216, a camera system 214 having one or more cameras, a state estimator 280, and a fiducial creation and detection module 270. In one embodiment, the communication device 206 implements a wireless communication link with the APD 106 and/or the optional portable device 114.

In one embodiment of the system 100, the robot 104 uses the camera data from camera, lidar, or depth camera to track its relative position in the building and periodically receives updates with total station data to remove the drift from the camera data and provide corrections to its position estimate.

In some implementations, a state estimator 280 combines available location information to generate an estimate of the most likely position of the mobile robot at a given time based on combining information from all available sources. This can also be described as “sensor fusion” in that the state estimator 280 generates an estimate of the most likely position and orientation of the mobile robot that takes into account the latency of each data source, the accuracy limitations of each data source, and information over a previous window of data. For example, an APD 106 may provide accurate location information but be subject to communication time delays of network 102 or generate data infrequently. Also, an APD 106 may be temporarily unavailable if the line of sight is temporarily lost, such as when the mobile robot moves behind a post, a wall, or an obstacle. Local sensors 202 and 218 may have less latency than an APD, but may also be less accurate, particularly if relied upon for an extended period of time. GPS sensor 210 may be capable of providing location data in some construction sites but not others.

The state estimator 280 generates a best estimate of the mobile robot location and orientation that takes into account the availability and limitations of different types of data, as well as information on a sequence of recent location measurements. For example, the state estimator 280 may use a sensor fusion algorithm based on statistical weighting techniques.

The robot's onboard sensors 202, 210, and 214 track its own location. Sensors 202 may include any common robot sensors including Lidar, radar, time of flight, depth or other 3D cameras, sonars, etc. For example, cameras 214 may be mounted on the robot 104 in various directions to observe its environment and determine its position as it moves. A visual odometry module 218 supports visual odometry. One technique of particular interest is using algorithms known in the state of the art under the term “visual odometry” (VO). These algorithms track the relative motion of an object using the motion of images captured by the camera system 214. Since these systems track relative motion, they are accurate over short to medium distances, but suffer from slow drift when tracking over larger distances.

The mobile base 204 may be implemented using a variety of different drive technologies, including holonomic implementations with omni-directional wheels and non-holonomic implementations in which the wheels are not omni-directional. Non-holonomic drive systems, such as with differential 2-wheel drive, sometimes known as a differential wheeled robot (DWR), are typically cheaper to implement than a robot with true omni-directional drive (e.g., “omni” wheels or “Mecanum” wheels). However, DWR implementations have more difficulties achieving precise navigation. In some implementations, the navigation is switched from point-to-point navigation to line navigation when conducting a printing pass.

In one implementation, the robot 104 relies primarily on data from an APD 106 when available, and onboard sensors 202 when absolute position information is not available. For example, a mobile robot 104 navigating on a construction site may have line of sight to a TS temporarily occluded by a concrete pillar as it drives past the pillar. Using this implementation, a robot 104 could calculate its location using the TS while it's visible, fall back on visual odometry using its visual odometry module 218, or other sensors, while the visual connection is lost, and resume use of the TS-based location once it reappears in view.

In some implementations, the robot 104 uses the images from multiple cameras 214 to create a very precise estimate of its movement through the space. For example, the robot 104 may have a downward facing camera located at the front and back of the body 204, and/or at the two side edges of the robot 104. In this configuration, each camera needs enough magnification to resolve the fine detail in the driving surface. As an example, the fine detail of the grains in the cement can be used to uniquely identify a location. This can be done with any surface that requires layout markings, as long as the surface has enough detailed features. Examples include cement, tile, wood, or temporary floor coverings such as Ram Board.

In some implementations, a fiducial creation and detection module 270 is used to coordinate actions of the mobile robot to generate fiducials (e.g., fiducial marks) and later use the printed fiducials. As an example, a fiducial may be used to aid the mobile robot to compute its precise location.

In one embodiment, the robot 104 moves in the forward direction, images collected from the back camera are compared to images collected by the front camera at the same location. By finding the precise alignment between the two images, and knowing the precise distance between the two cameras, the robot 104 can measure the distance it has moved between acquiring the two images. Similarly, by observing the motion as measured by the left and right cameras, the robot can track its angular orientation precisely.

In one implementation, a printing robot 104 also comprises an obstacle detector 220 that detects the presence of obstacles. Any number of sensors commonly used in robotics for obstacle detection can be employed. Some examples include 3D depth cameras such as the Intel RealSense, time of flight sensors, 2D LiDAR, sonar, radar, signal point optical sensors, or mechanical sensors used for bumper and mechanical collision detection. Sensors can also be employed to detect a cliff such as an empty elevator shaft, stairway, or edge of a building where the walls are not yet constructed. When the robot detects an obstacle, the robot may choose to drive around the obstacle such that the area under the obstacle is not printed on. If the obstacle is large it may not continue in that portion of the building. It may also notify an operator about the presence of the obstacle such that it can be cleared and a good print quality can be achieved. For small holes such as penetrations, the robot can drive over the obstacle such that its wheels straddle the penetration, allowing it to print an alignment mark over the penetration so the location of the penetration can later be checked.

General information on the lines and other features to be drawn may be obtained from the Building Information Models (BIM), CAD, or other architectural drawings. These may be represented in many forms, such as a Revit model, or a DXF or DWG file. However, they may also be represented in any proprietary file containing a list of lines or other objects.

The features to be drawn may include combinations of lines, letters, numbers, and symbols. For example, in some implementations, the lines and features correspond to images to be printed by a printhead of the print system. A printhead permits printing not only lines, but letters, numbers, and symbols. This permits, for example, a line to be drawn along with any letters, numbers, or symbols that are useful at a construction site. The determination of the features to be drawn may be processed by another computing entity and then received by the mobile printing robot controller. However, more generally, a version of this relevant BIM/drawing information may be stored in the controller 295 along with information corresponding to an obstacle map. In some implementations, this version may include two files with the first file describing the lines to be drawn and the second file describing obstacles to be avoided. For example, the obstacle map may include features derived from the BIM/drawing information as well as additional obstacle information collected on the construction site. The lines to be drawn may be a subset of the lines in the BIM that represent one layer or one area to be printed.

In one application of mobile printing robot technology, a robot 104 is used to generate markings on a horizontal surface of a building under construction, where such markings correspond to information extracted from a digital model of the building under construction, such as architectural drawings, Building Information Models (BIM), or Shop Drawings created by individual trades. Such drawings are typically drawn up by architects or others who design the building to be built. In current practice, these drawings are typically printed on large sheets of paper and given to workers in the field, who have the responsibility for marking pertinent information from the drawings onto the surface of each floor under construction. These marks may take the form of lines (e.g. to denote the locations of framing tracks for interior walls), points (e.g. to denote locations where ductwork will be hung from the ceiling or recessed lighting is to be installed), or text (e.g. to distinguish where fire-rated vs regular drywall is to be hung).

A mobile printing robot 104 that generates the correct markings on the surface must first extract the pertinent information from a digital model, such as using an Application Programming Interface (API) to access the model, or by reading the model into memory and extracting features and points of interest from the model. This extraction may be done on a robot, or it may be done in a separate computing system, such as the tablet computer 114, or located offsite or in the cloud, and communicated to the robot using some form of network. For example, this may be done by a BIM module 222 that is operational on the robot 104, or it may be done by a BIM server (not shown) located on the same network 102 as the robot 104.

During the construction process, the BIM model may be changed to reflect changes in the desired design of the building, or to accommodate conflicts observed during the building process. When these changes occur, it is desired to update the markings on the floor so that the construction crews work off of the latest information. In one implementation, a mobile printing robot 104 is able to update previous markings by first covering the surface with like-colored material (such as concrete-colored paint) and then generating a new set of markings on top of the colored material, effectively “erasing” the original markings and replacing them with new ones. In another implementation, a mobile printing robot 104 keeps track of the markings that have previously been generated, compares the old markings against the current set of markings, and only erases and re-generates the markings in areas where there is a difference between the old and the new markings. In one implementation, a robot uses a camera or other sensing device to perceive the old markings on the floor for comparison with the desired markings. In another implementation, a robot remembers what has been previously printed, and compares its memory of the previous printing run with the new markings that are to be printed, in order to calculate the areas to be erased and re-printed.

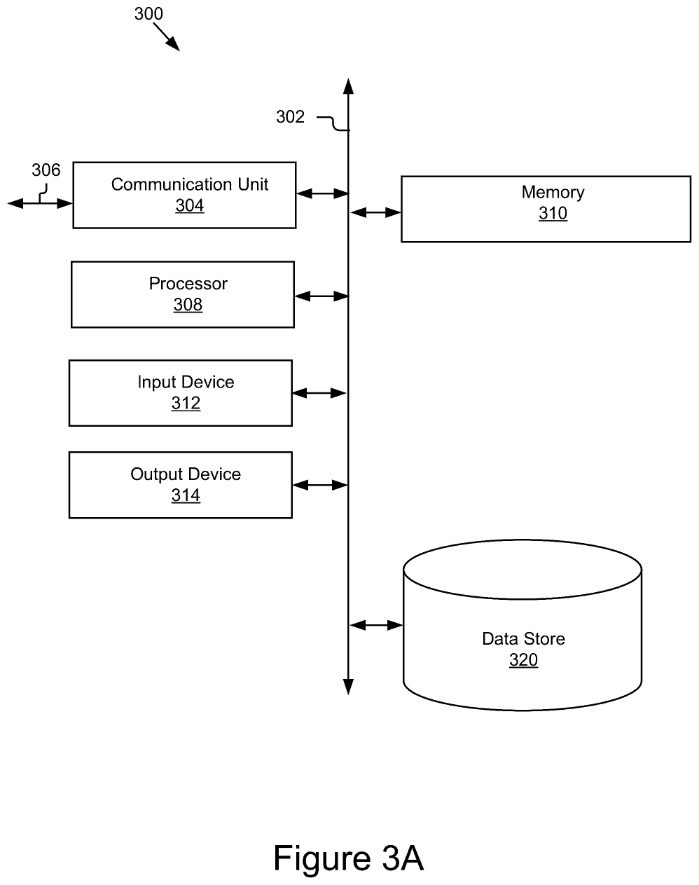

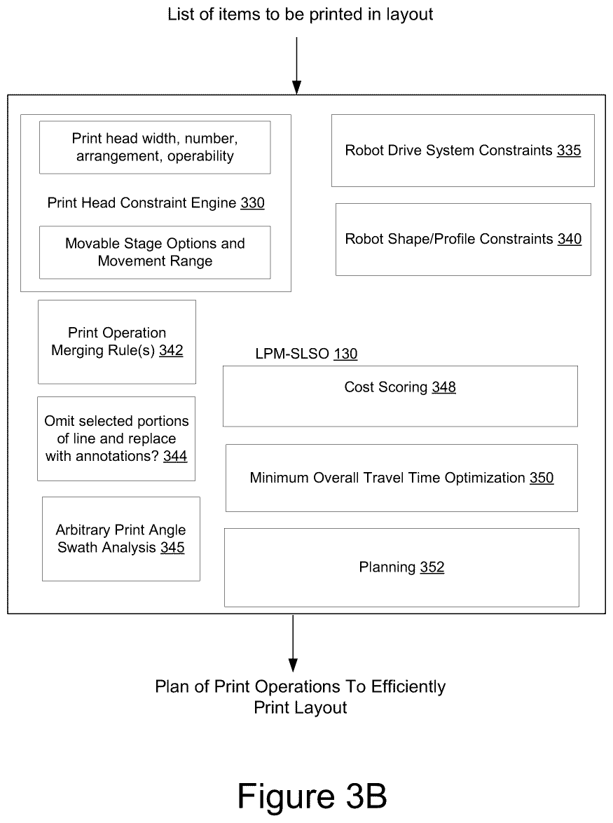

FIG. 3A is a block diagram of an example computing device 300, which may represent a computing device configured to implement modules depicted in FIGS. 1 and 2, depending on the implementation.

As depicted, the computing system 300 may include a processor 308, a memory 310, a communication unit 304, an output device 314, an input device 312, and a data store 320, which may be communicatively coupled by a communication bus 302. The computing system 300 depicted in FIG. 3A is provided by way of example and it should be understood that it may take other forms and include additional or fewer components without departing from the scope of the present disclosure. For instance, various components of the computing device may be coupled for communication using a variety of communication protocols and/or technologies including, for instance, communication buses, software communication mechanisms, computer networks, etc. While not shown, the computing system 300 may include various operating systems, sensors, additional processors, and other physical configurations. The processor 308, memory 310, communication unit 304, etc., are representative of one or more of these components.

The processor 308 may execute software instructions by performing various input, logical, and/or mathematical operations. The processor 308 may have various computing architectures to method data signals (e.g., CISC, RISC, etc.). The processor 308 may be physical and/or virtual and may include a single core or plurality of processing units and/or cores. In some implementations, the processor 308 may be coupled to the memory 310 via the bus 302 to access data and instructions therefrom and store data therein. The bus 302 may couple the processor 308 to the other components of the computing system 300 including, for example, the memory 310, the communication unit 304, the input device 312, the output device 314, and the data store 320.

The memory 310 may store and provide data access to the other components of the computing system 300. The memory 310 may be included in a single computing device or a plurality of computing devices. In some implementations, the memory 310 may store instructions and/or data that may be executed by the processor 308. For example, the memory 310 may store instructions and data, including, for example, an operating system, hardware drivers, other software applications, databases, etc. which may implement the techniques described herein. The memory 310 may be coupled to the bus 302 for communication with the processor 308 and the other components of computing system 300.

The memory 310 may include a non-transitory computer-usable (e.g., readable, writeable, etc.) medium, which can be any non-transitory apparatus or device that can contain, store, communicate, propagate, or transport instructions, data, computer programs, software, code, routines, etc., for processing by or in connection with the processor 308. In some implementations, the memory 310 may include one or more of volatile memory and non-volatile memory (e.g., RAM, ROM, hard disk, optical disk, etc.). It should be understood that the memory 310 may be a single device or may include multiple types of devices and configurations.

The bus 302 can include a communication bus for transferring data between components of a computing device or between computing devices, a network bus system including the network 102 or portions thereof, a processor mesh, or combination thereof, etc. In some implementations, various components operating on the computing device 300 (operating systems, device drivers, etc.) may cooperate and communicate via a communication mechanism included in or implemented in association with the bus 302. The software communication mechanism can include and/or facilitate, for example, inter-method communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

The communication unit 304 may include one or more interface devices (I/F) for wired and wireless connectivity among the components of the system 100. For instance, the communication unit 304 may include, but is not limited to, various types of known connectivity and interface options. The communication unit 304 may be coupled to the other components of the computing system 300 via the bus 302. The communication unit 304 can provide other connections to the network 102 and to other entities of the system 100 using various standard communication protocols.

The input device 312 may include any device for inputting information into the computing system 300. In some implementations, the input device 312 may include one or more peripheral devices. For example, the input device 312 may include a keyboard, a pointing device, microphone, an image/video capture device (e.g., camera), a touch-screen display integrated with the output device 314, etc. The output device 314 may be any device capable of outputting information from the computing system 300. The output device 314 may include one or more of a display (LCD, OLED, etc.), a printer, a haptic device, audio reproduction device, touch-screen display, a remote computing device, etc. In some implementations, the output device is a display which may display electronic images and data output by a processor of the computing system 300 for presentation to a user, such as the processor 308 or another dedicated processor.

The data store 320 may include information sources for storing and providing access to data. In some implementations, the data store 320 may store data associated with a database management system (DBMS) operable on the computing system 300. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations.

The data stored by the data store 320 may be organized and queried using various criteria including any type of data stored by them. The data store 320 may include data tables, databases, or other organized collections of data.

The data store 320 may be included in the computing system 300 or in another computing system and/or storage system distinct from but coupled to or accessible by the computing system 300. The data stores 320 can include one or more non-transitory computer-readable mediums for storing the data. In some implementations, the data stores 320 may be incorporated with the memory 310 or may be distinct therefrom.

The components 304, 308, 310, 312, and/or 314 may be communicatively coupled by the bus 302 and/or the processor 308 to one another and/or the other components of the computing system 300. In some implementations, the components 304, 308, 310, 312, and/or 314 may include computer logic (e.g., software logic, hardware logic, etc.) executable by the processor 308 to provide their acts and/or functionality. In any of the foregoing implementations, these components 304, 308, 310, 312, and/or 314 may be adapted for cooperation and communication with the processor 308 and the other components of the computing system 300.

### Line Printing Merging And Selective Line Section Omission (LPM-SLSO)

As previously discussed, a Line Printing Merging And Selective Line Section Omission (LPM-SLSO) 130 engine optimizes the printing of lines of a layout. The LPM-SLSO 130 engine may be implemented in the mobile printing robot, although more generally some or all of its functionality could be implemented using an external computing device, such as in a tablet device used by an operator.

General information on the lines to be drawn may be obtained from the BIM or architectural drawings. However, the mobile printing robot has constraints on its printing capabilities. Some of these constraints arise on the arrangement of its print heads. Additionally, there are printing constraints based on the physical size and shape (contour) of the mobile robot and its drive system.

A mobile robotic printer is tasked with printing a set of items (lines, text, and other content), each at a specific location on a large surface that extends beyond the physical size of the printer itself. To print each element, the robotic printer must travel across the surface to the element's designated location, then travel along a specific path as it deposits ink from a print head in such a way as to draw the element on the surface. Printing one element in this way is considered a single print operation. A single printing operation thus includes a printing path or pass.

The total time taken to travel to the locations of all items the robotic printer is tasked with may be substantial. To reduce the total time taken to print all items, the robotic printer or its external controller may optimize how it prints the items. This may include analyzing the complete set of items to be printed for a layout and then making decisions to reduce the time required to print all of the items in the set.

One optimization is to use an algorithm to choose an ordering of items that minimizes the overall travel time. Another optimization is to analyze the set of items with an algorithm that determines which combinations of items the mobile robotic printer is capable of printing in a single print operation, and then instruct the robotic printer to print each of those combinations in a single print operation. An additional optimization is to analyze the set of items for portions that may be omitted and replaced with visual annotations that enable a viewer to infer what was omitted.

FIG. 3B is a block diagram of an example of components of the LPM-SLO 130 engine. In one implementation, a print head constraint engine 330 identifies constraints on the arrangement of its print heads. These may include the transverse width, W, of each print head and the nominal position of each print head. For example, an individual print head may have a fixed position. If there are two or more print heads, each could have a different fixed position (e.g., left, center, right). The number of print heads and their arrangement may thus be considered. Additionally, if there are two or more print heads, the operability of each print head may be considered in some implementation, such as whether a print head has ink.

Additionally, the print head constraint engine 330 may consider whether each print head is capable of having its transverse position moved on a movable stage via an actuator. For example, while each print head has a width, W, there is a transverse range, R, over which the print head may be moved by a movable stage.

In one implementation, robot drive system constraints 335 are taken into account. For example, a robot may have a turn radius that limits how tightly it can turn, how quickly it can navigate and accurately align the robot along a line to be printed, etc.

Robot shape/profile constraints 340 may be considered. For example, the shape of the robotic printer does not have to be symmetric. As one example, the print head(s) may be located toward a front end of the printing robot. Overall, a combination of factors may be important, such as the arrangement of the print head(s), whether there is a movable stage, the shape/profile of the printing robot, and constraints on the drive system. A variety of factors may favor printing items in as few print operations as possible. For example, if two lines can be printed simultaneously while the robotic printer moves from point A to point B along a line trajectory, that's more efficient than printing the first line in a first printing operation as the robot moves from point A to point B, then navigating the robotic printer back to point A to print the second line from point A to point B in a second print operation.

Print operation merging rule(s) 342 may include one or more rules to determine when items in an initial list of items are candidates to be merged in a single print operation, or in a sequence of single print operations.

In some implementations, an option is provided by engine 344 to omit selected portions of individual lines of a layout and replace the omitted portions with annotations.

In some implementations, an arbitrary print angle swath analysis engine 345 supports printing swaths.

If there is more than one possible optimization, a cost scoring engine 348 determines a minimum cost solution where cost scoring may be based on a variety of factors for printing a set of items in different ways. In some implementations, a minimum overall travel time engine 350 may compare different options for printing a set of items based on the overall travel time, which in in some sense is the simplest form of cost function.

In some implementations, an option is provided for omitted portions of some types of lines

A planning engine 352 generates a plan for printing items of the layout. The plan may, for example, identify pathways that allow the robot to print the layout more efficiently. The various optimizations may be used alone or in combinations or subcombinations.

Reducing the number of printing operations has a correlation with reducing the total time required to print a layout. An individual print operation may, for example, require time to navigate the robotic printer to a starting point and perform accurate printing. For example, to print a line from point A to point B includes the time to navigate the robotic printer to point A. Thus, if there is an option available to print more than one item in a printing operation this may significantly reduce the overall time required for a printing robot to print the layout.

Planning decisions may also be made regarding whether to print a particular line (or line segment) with other lines or line segments during an individual printing operation or on a subsequent printing operation. For example, once the mobile printing robot has navigated to print a line, it may be more efficient to also print a parallel line, line segment, or text in the same printing operation instead of doing an additional printing operation.

The LPM-SLO 130 engine may, for example, determine its printing and drive system capabilities in a configuration step or by other techniques, such as by a discovery technique, or an active monitoring technique. This will depend, in part, on implementation details of the printing robot.

The LPM-SLO 130 engine may be provided with a set of rules to determine when two or more lines can be printed in a single printing operation (i.e., their printing merged into a single printing pass instead of being printed in two or more different printing passes). This can include identifying the set of items to be printed, and determining the combination of times that the robotic printer is capable of printing. performing one or more tests regarding whether shapes can be merged.

A series of optimizations is discussed below.

### Within Print Head Width

One example of a combination that the robotic printer may print in a single print operation is a set of items that are close enough in location that the printer's print head is able to span them as the robot travels along the printing path. The optimization algorithm implemented by the LPM-SLO 130 engine takes into account the mechanical design of the print head, including the width of the print head and its print resolution (usually measured in dots per inch or DPI), to determine which items may be printed in combination.

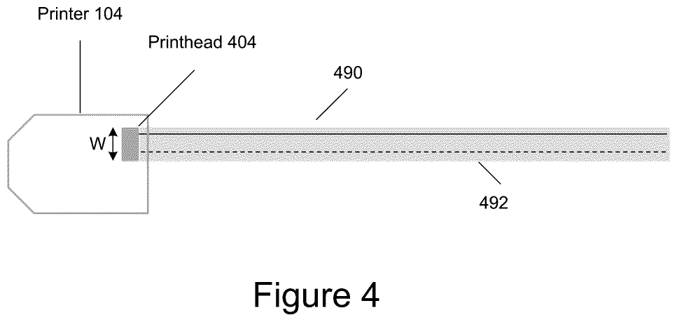

In FIG. 4, an outline of a robot printer 104 (illustrates as a six-sided polygon) is shown along with an outline of print head 404 (the rectangle). The LPM-SLO 130 engine determines that the robotic printer can print two parallel lines in one print operation, because the distance between the lines is less than the width W of the print head. This is illustrated by the two lines (top solid line 490 and bottom dashed line 492) fitting within the width of the print head. These two lines illustrate what will be printed during a print operation in which the printing of the two lines is performed in one print operation.

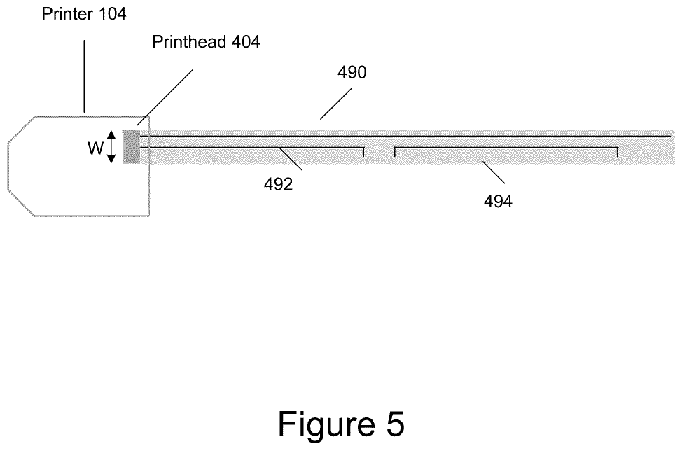

In FIG. 5, the LPM-SLO 130 engine determines that the robotic printer (the six-sided polygon) can print multiple parallel lines 490, 492, and 494, some of which start and end at different locations and some of which are bounded by corner marks as illustrated, because the distance between the lines is within the width, W, of the print head (the rectangle within the robot printer).

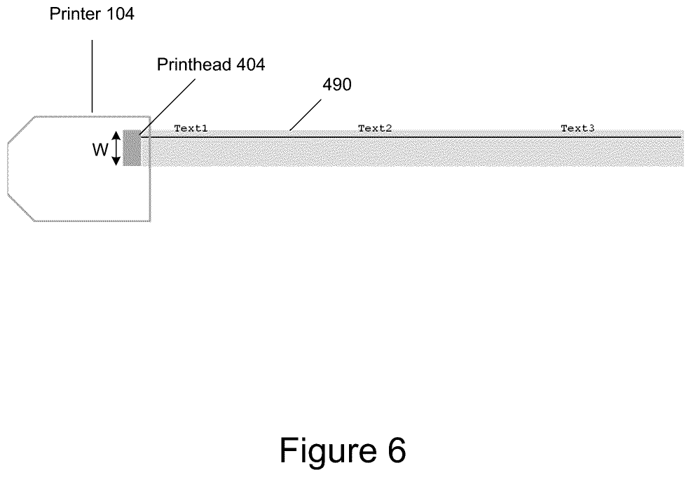

In FIG. 6, the algorithm determines that the robotic printer 104 can print the line 490 and the three separate text items (Text1, Text2 and Text3) in one operation, because the distance between the line and text items is less than the width, W, of the print head.

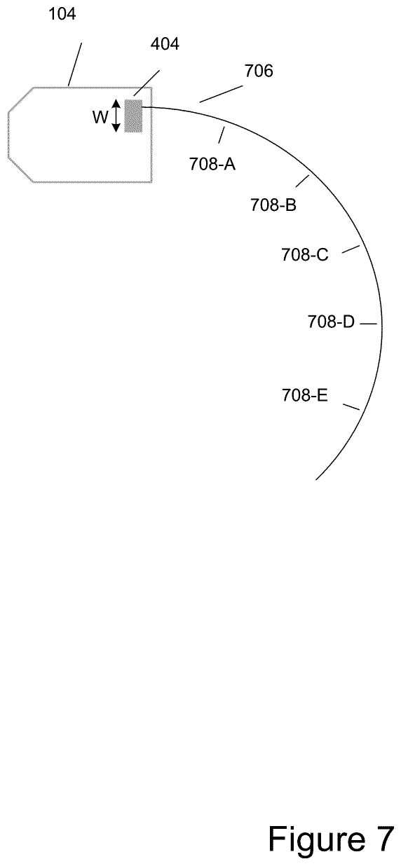

In FIG. 7, the algorithm implemented by the LPM-SLO 130 engine determines that the robotic printer 104 can print the curved line 702 as well as the small tick marks 704-A, 704-B, 704-C, 704-D, 704-E, adjacent to the curved line 702, because the tick marks and the line fit within the width W, of the print head 402 while the robotic printer 104 travels a curved printing path. In this case, the algorithm takes into account the turning radius of the robotic printer 104, allowing only combinations that have less curvature than the turning radius.

### Moving the Print Stage

Another example of a combination that the robotic printer may print in a single print operation takes advantage of a print head on a movable stage within the robotic printer to adjust the transverse position of the print head. The movable stage may, for example, have a range, R, of transverse movement side-to-side relative to the path of the robotic printer. The robotic printer may print items in a single print operation that are close enough in location that the robotic printer is able to shift the position of the print head to reach the location of each element as the robot travels along the printing path. The LPM-SLO 130 engine takes into account the mechanical design of the moving print stage, utilizing its mechanical range of traversal to determine which items are within range of a straight-line path. The LPM-SLO 130 engine may also take into account temporary mechanical problems that limit the range of traversal, such as damage or debris blocking the motion of the print head beyond a certain point, which may be observed and measured by sensors in the robotic printer and reported out as inputs to the algorithm.

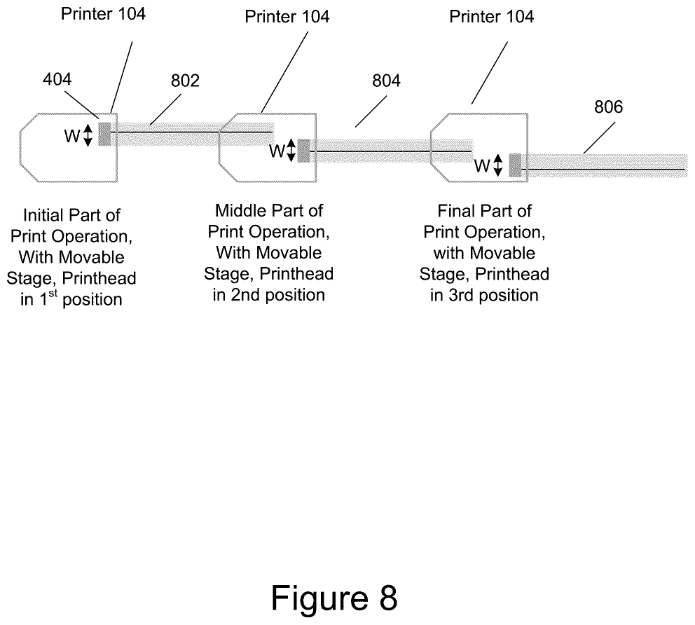

In FIG. 8, the LPM-SLO 130 engine determines that the robotic printer can print three lines 802, 804, and 806 offset in their starting locations in one operation, by moving the print head within reach of each one. In this example, the three lines 802, 804, and 806 are printed while the robotic printer moves along a straight-line path while adjusting the movable print stage.

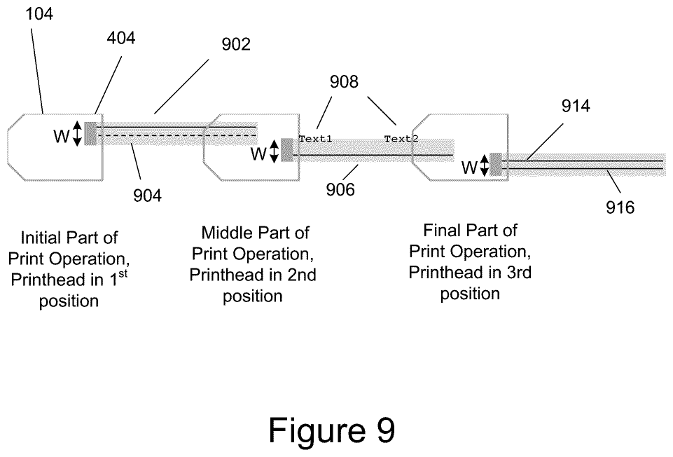

In FIG. 9, the LPM-SLO 130 engine determines that the robotic printer 104 can print three smaller combinations of items 902, 904, 906, 908, 912, 914, and 916 in one combined print operation, taking advantage of both the print head width and the moving print head to print lines and text.

### Multiple Print Heads

Another example of a combination that the robotic printer may print in a single print operation takes advantage of multiple print heads within the robotic printer. The robotic printer may print items in a single print operation that are located such that multiple print heads can reach them as the robot travels along the printing path. The LPM-SLO 130 engine takes into account the mechanical placements of the print heads relative to each other. The LPM-SLO 130 engine may also account for temporary mechanical problems with one or more print heads reported by the robotic printer, adjusting the results to avoid combinations that would require the use of temporarily unavailable print heads.

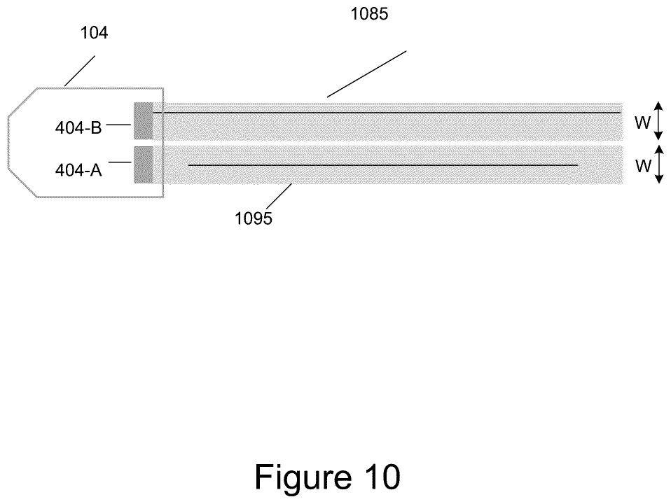

In FIG. 10, the LPM-SLO 130 engine determines that the robotic printer can print two parallel offset lines 1085 and 1095 at such a distance that multiple print heads 404-A and 404-B can reach them simultaneously. The lines 1085 and 1095 do not necessarily start and end at the same location along the printing path. It is enough that the robotic printer is able to reach each of them at some point along the overall printing path of a single print operation.

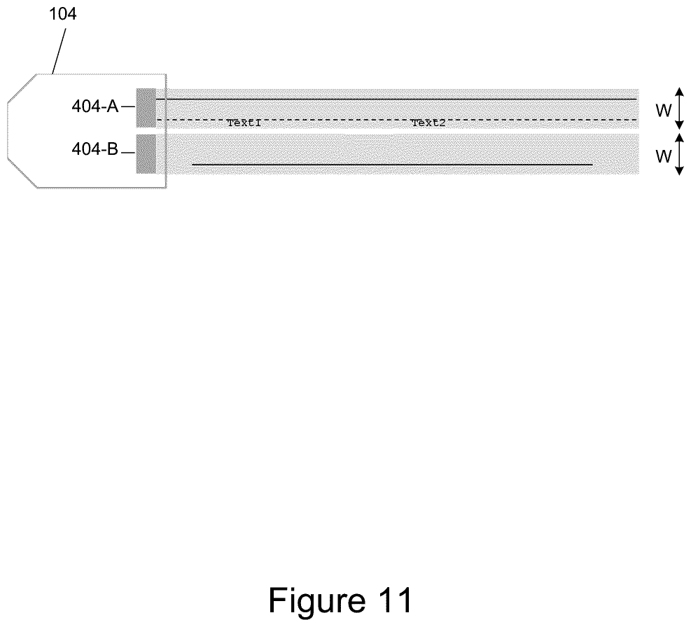

In FIG. 11, the LPM-SLO 130 engine first determines that the robotic printer can print each of the two smaller combinations of items within the width, W, of a print head, and then determines that both combinations (in this examples of lines and text) are reachable by the multiple print heads 404-A and 404-B along the overall printing path of a single print operation.

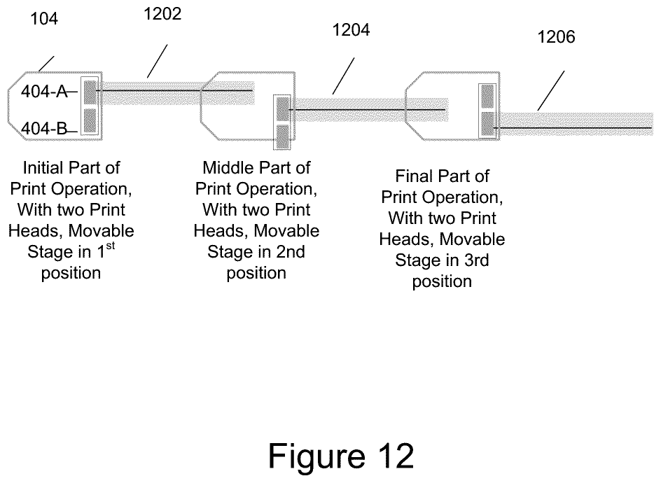

FIG. 12 illustrates using multiple print heads 404-A and 404-B on a moving stage. The LPM-SLO 130 engine determines that the robotic printer can print three lines 1202, 1204, and 1206 offset in their starting locations in a single print operation by moving any one of the print heads within reach of each one. For example, to print the three lines, line 1202 is printed using print head 404A (in this example, in a default position). Line 1204 is printed using print head 404-A with the movable stage shifted to the right. Line 1206 is printed using print head 404-B, with the moving states shifted slightly to the right.

### Multi-swath

Another example of a combination involves the robotic printer printing a combination of items in a series of adjacent swaths (e.g., first swath, second swath, third swath, forth swath) of a width equal to the width of a print head. For a sufficiently large number of densely located items, printing the items together in swaths rather than as individual items reduces the total number of print operations.

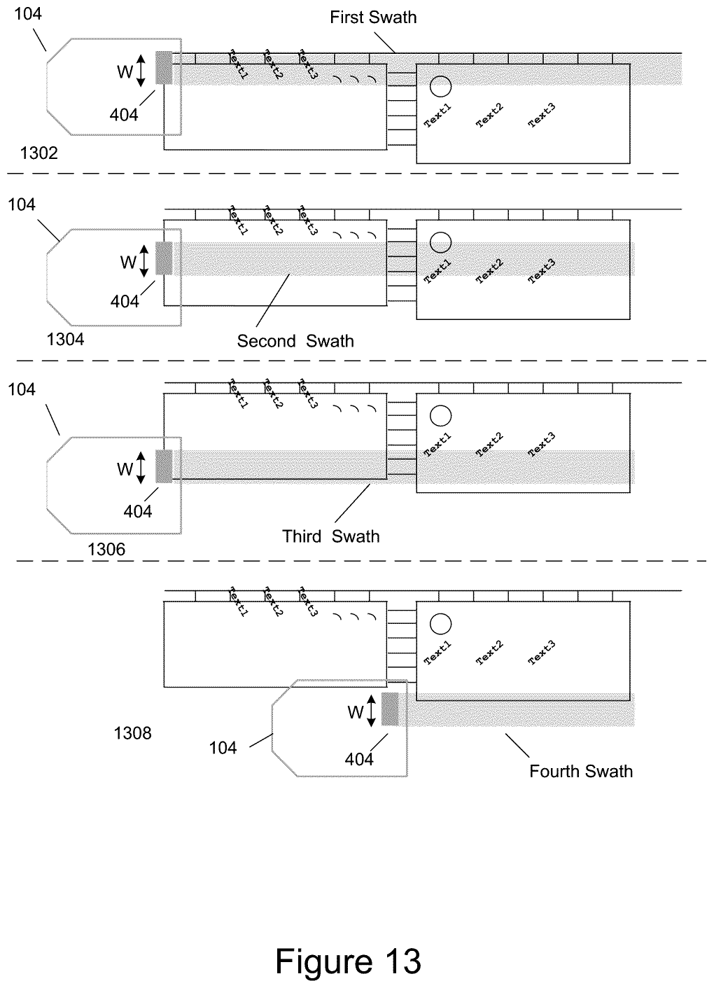

In FIG. 13 the LPM-SLO 130 engine determines that the robotic printer can more efficiently print a large number of densely located items as a small number of adjacent swaths illustrated in sections 1302, 1304, 1306, and 1308 to be printed in printing operations, rather than printing each item (e.g., lines and text items) in a separate print operation. For example, the LPM-SLO 130 engine may compare printing in swaths versus printing individual items.

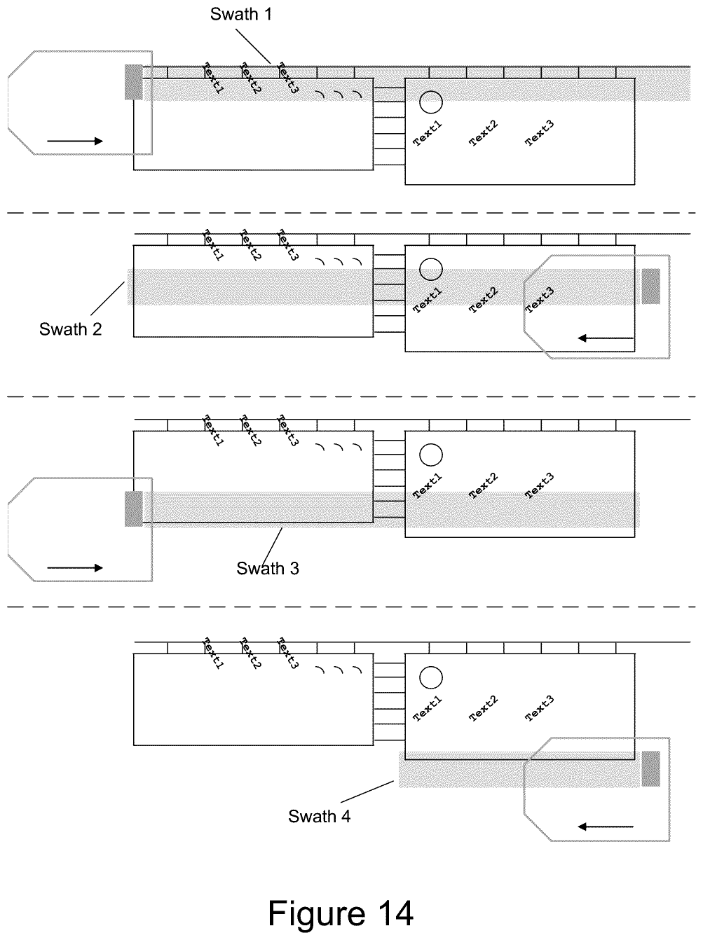

In FIG. 14, the LPM-SLO 130 engine determines that the robotic printer can reduce travel time between swaths by printing each swath in the opposite direction from the previous swath.

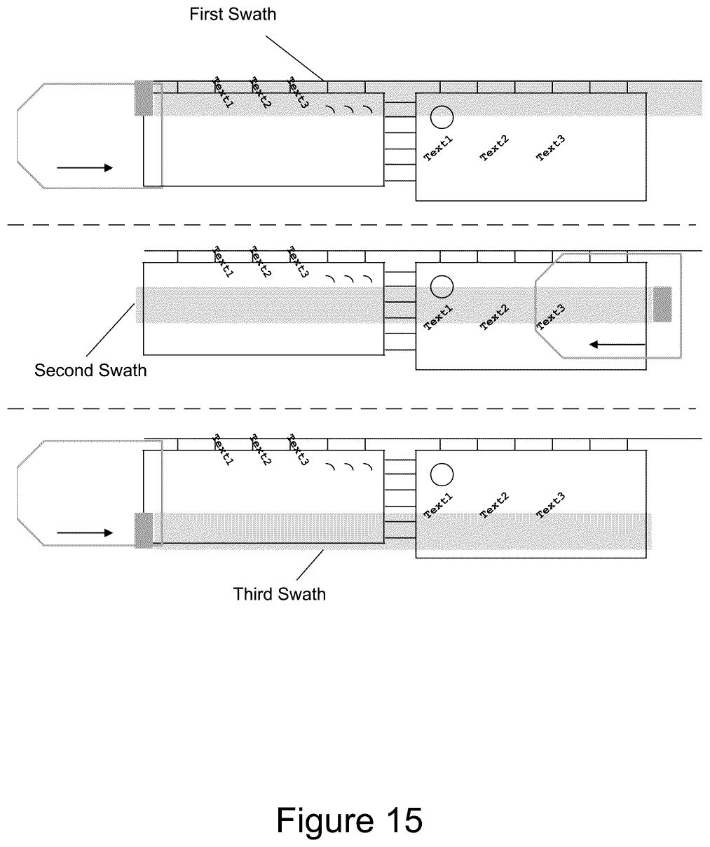

In FIG. 15, the LPM-SLO 130 engine determines that the robotic printer may print three of the swaths by traveling forward and backward along precisely the same path, by moving the print head in alignment with the position of each swath. For example, the first swath may be printed with the printhead extended to the left, the second swath may be printed with the printhead in a center position, and the third swath printed with the print head extended to the right.

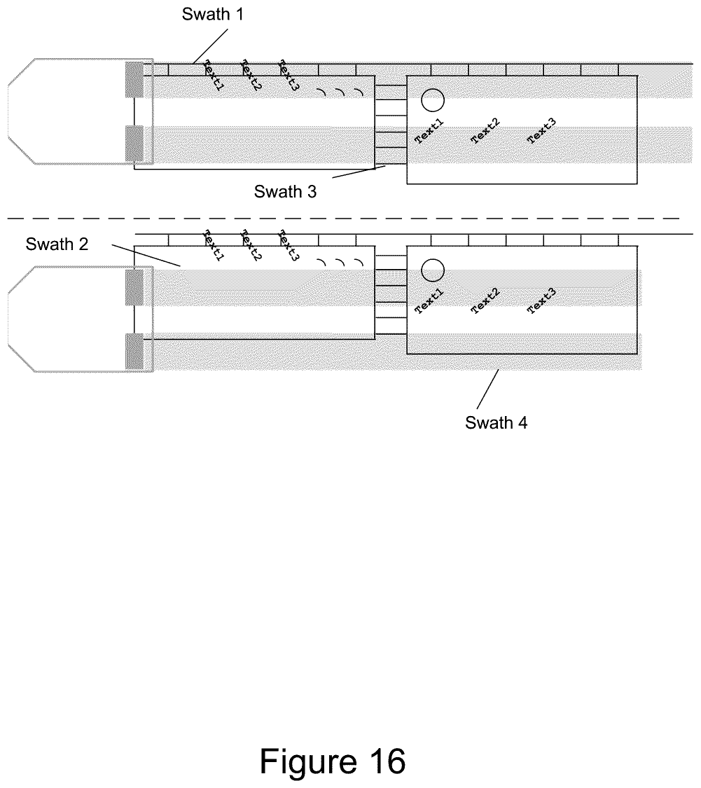

In FIG. 16, the LPM-SLO 130 engine determines that the robotic printer can further reduce the number of print operations by printing multiple swaths with multiple print heads. In this example, the robotic print head has two print heads.

### Omitting Portions of Items

Another example of optimizing the number of print operations involves omitting portions of items that can be inferred by a viewer of the printed content. In this case, the LPM-SLO 130 engine implements a set of annotations that it introduces into the printed content as substitutes for the full content, which act as visual references for the viewer to infer the full content.

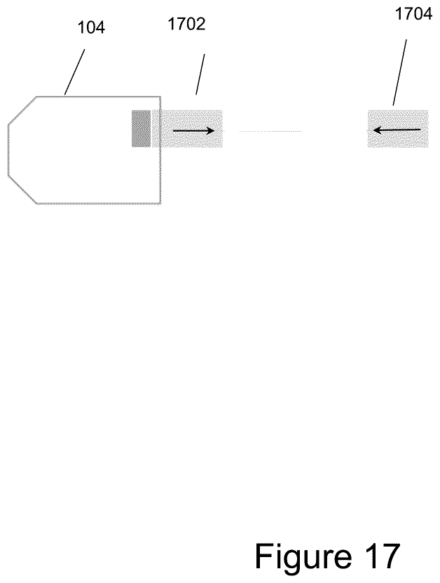

In FIG. 17, the LPM-SLO 130 engine implements an annotation representing a complete line. This may be implemented in different ways, but may, as an example, consist of two short arrows 1702 and 1704 at the endpoints of the line pointing toward each other. The robotic printer only prints the short arrows rather than the full line, which is significantly less content to print. The viewer can infer the intended full line by understanding the arrow representation.

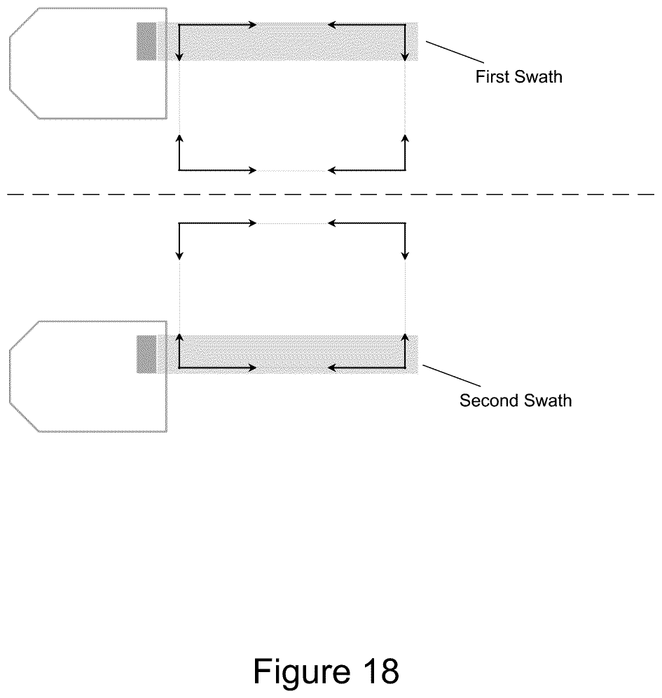

Referring to FIG. 18, in one implementation the LPM-SLO 130 engine can make use of a parameter that determines how aggressively content will be omitted. In FIG. 18, an aggressiveness parameter sets an upper bound on the length of line that will be omitted and annotated with arrows. FIG. 18 also illustrates the use of swaths.

### Full Analysis Example

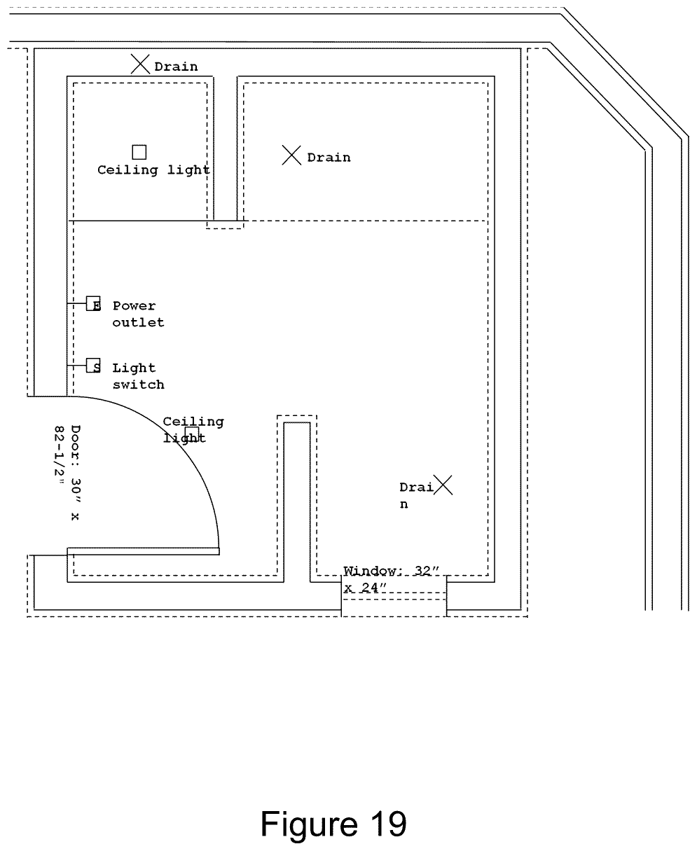

FIG. 19 is an example of a construction layout of a restroom with 95 separate items to be printed, which include both lines and text. In one form, the layout is represented as vectors: a set of individual shapes defined by coordinates indicating where the shapes are positioned relative to a local or global coordinate system, the set of which are provided to the LPM-SLO 130 engine. In another form, the layout is represented as an image bitmap, within which an image analysis algorithm is able to locate contiguous shaded pixels against the transparent background, and assemble them into shapes which are provided to the LPM-SLO 130 engine.

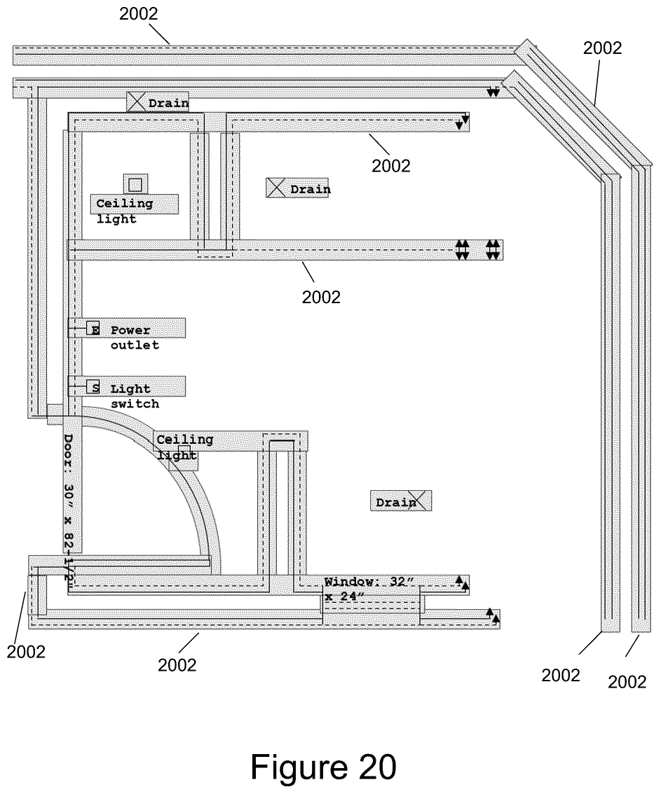

Using the techniques illustrated previously, the LPM-SLO 130 engine analyzes the complete set of items and finds all combinations that the robotic printer is capable of printing. The shaded boxes outlined in red (also illustrated as outline 2002) in FIG. 20 represent the paths traveled by the robotic printer during individual print operations. In this example, only 31 print operations are required to print all 95 items.

The previously described example algorithms may be implemented as a method implemented by the LPM-SLO 130 engine to reduce the number of print operations required to print a set of items of a layout by combining/merging feature to be printed.

The previously described example algorithms may be implemented as a method implemented by the LPM-SLO 130 engine to reduce the number of print operations required to print a set of items of a layout by combining/merging feature to be printed.

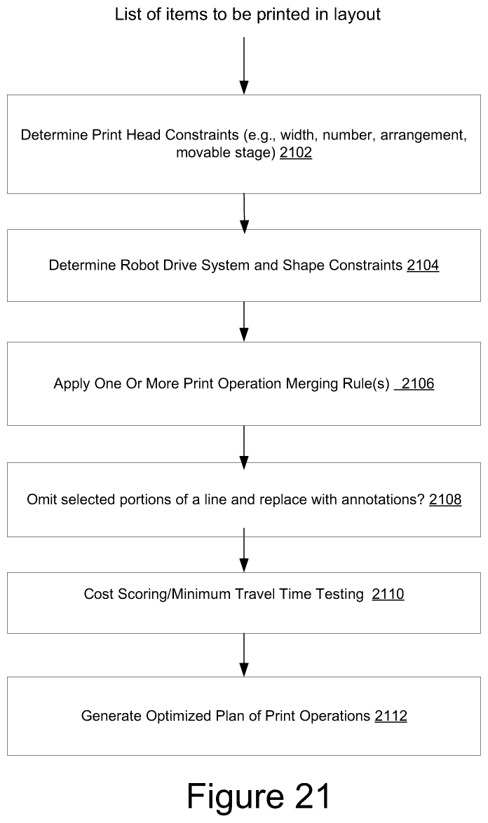

Referring to the flowchart of FIG. 21, a method may start with a list of all items to be printed for a layout and their shapes. The robot constraints may be evaluated (or reevaluated). In block 2102, print head constraints are determined, such as print head width, number, arrangement, and whether there is a movable stage. In the field, an individual ink jet cartridge print head may run out of ink as one example. Thus, a robotic printer designed to operate with two print heads may in some cases have only one print head operable in the field. If there is a movable stage, it may or may not be fully operational in the field.

In block 2104, the robot drive system and shape constraints are determined. The robot drive system and shape constraints are less likely to change in the field, although there are technical possibilities such as portions of a drive system not operating at full health or a different outer shell being used in the field.

In any case, some constraints are temporary and others are fixed in terms of normal operations of the robotic printer. A configuration process or a discovery process may be used to identify constraints. In any case, the algorithm needs to know the constraints on operation.

In block 2106, one or more print operation merging rules are applied to different parts of a layout. This may include as previously discussed option to print items within the width of a print head, options to print items using two or more print heads, options to use a movable stage, options to print swaths, etc. In some implementations, selected portions of a line may be omitted, as indicated in block 2108. If there is more than one option to optimize the print operations, additional analysis can be performed in block 2110, such as cost scoring/minimum travel time testing. In block 2112, an optimized plan of print operations is generated.

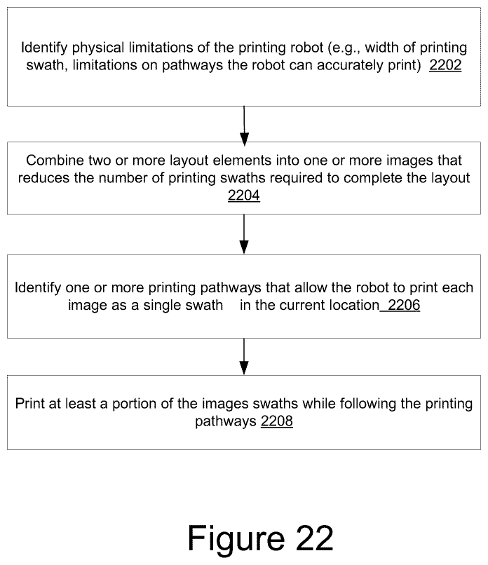

FIG. 22 is a flowchart of a method of printing a layout of a plurality of layout elements as a series of single swath images printed by a printing robot. In block 2202, physical limitations are identified of the printing robot, including the width of a printing swath and the limitations on the pathways in which the robot can travel while printing accurately. In block 2204, two or more layout elements are combined into one or more images in a way that reduces the total number of printing swaths required to complete the layout. In block 2206, one or more printing pathways are identified that allow the robot to print each image as single swath in the correct location. In block 2208, the printing robot prints at least a portion of the image swaths while following the printing pathways.

A detailed example implementation of a method implemented by the LPM-SLO 130 engine is as follows:

Start with a list of input shapes.

For each shape:

Find the set of all other shapes less than the print head width's distance from it.

Find the set of all other shapes along the same printing path.

Combine the two sets into one and save the set for that shape.

Across all shape sets, merge any two sets that share at least one shape in common.

For each remaining merged shape set:

Perform geometry tests on the shapes to determine the number of swaths needed to print the shapes, and the start and end point of each swath.

If multiple configurations of swaths are equally capable of printing the shapes, compute a cost score for each configuration.

Add the lowest cost configuration to the output list.

Submit the output list of merged shape sets and their print swaths to the robotic printer.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

To ease description, some elements of the system and/or the methods are referred to using the labels first, second, third, etc. These labels are intended to help to distinguish the elements but do not necessarily imply any particular order or ranking unless indicated otherwise.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD ROMs, and magnetic disks, read-only memories (ROMs), random access memories (RAMs), EPROMS, EEPROMs, magnetic or optical cards, flash memories including USB keys with non-volatile memory or any type of media suitable for storing electronic instructions, each coupled to a computer system bus.

The technology described herein can take the form of an entirely hardware implementation, an entirely software implementation, or implementations containing both hardware and software elements. For instance, the technology may be implemented in software, which includes, but is not limited to, firmware, resident software, microcode, etc. Furthermore, the technology can take the form of a computer program object accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input or I/O devices (including, but not limited to, keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi™) transceivers, Ethernet adapters, and Modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. As will be understood by those familiar with the art, the specification may be embodied in other specific forms without departing from the spirit or essential characteristics thereof. Likewise, the particular naming and division of the modules, routines, features, attributes, methodologies, and other aspects are not mandatory or significant, and the mechanisms that implement the specification or its features may have different names, divisions and/or formats.

Furthermore, the modules, routines, features, attributes, methodologies, and other aspects

of the disclosure can be implemented as software, hardware, firmware, or any combination of the foregoing. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment.

What is claimed is:

1. A method of combining items to print with a mobile robotic printing system into a single print operation, or into a smaller number of print operations than the number of items, the method comprising:
identifying a set of items to be printed on a surface at specific locations;
determining a set of fixed or temporary physical constraints of the robotic printing system;
combining items that the robotic printing system is capable of printing in fewer print operations than the number of items, based on the relative position and orientation of the items as well as the physical constraints of the robotic printing system; and
submitting the results of the algorithm as a new set of instructions to the robotic printing system.

2. The method of claim 1, comprising omitting portions of the set of items to be printed that may be inferred by a viewer of the remaining content that is printed.

3. The method of claim 2, wherein comprising inserting a set of annotations representing visual indicators of omitted content.

4. The method of claim 3, wherein the set of annotations includes at least one member from the group consisting of arrows, symbols, labels, and geometric patterns.

5. The method of claim 3, further comprising providing a set of selectable value parameters that indicate how aggressively to omit content with each annotation.

6. The method of claim 3, comprising input parameters to the algorithm that configure which annotations the algorithm shall introduce into the set of items to print and how aggressively the algorithm shall omit content with each annotation, such that portions of the set of items may then be omitted.

7. A system controller configured to:
receive information to identify items to print with a mobile robotic printing system;
combine items to print with a mobile robotic printing system into a single print operation, or into a smaller number of print operations than the number of items, including:
identify a set of items to be printed on a surface at specific locations;
determine set of fixed or temporary physical constraints of the robotic printing system;
utilize an algorithm that takes as input the set of items to be printed and the physical constraints of the robotic printing system, and combines items that the robotic printing system is capable of printing in fewer print operations than the number of items, based on the relative position and orientation of the items as well as the physical constraints of the robotic printing system; and
submit the results of the algorithm as a new set of instructions to the robotic printing system.

8. A method of printing layout consisting of a plurality of layout elements as a series of single swath images printed by a printing robot; the method comprising:
identifying physical limitations of the printing robot, including the width of a printing swath and the limitations on the pathways in which the robot can travel while printing accurately;
combining two or more layout elements into one or more images in a way that reduces the total number of printing swaths required to complete the layout;
identifying one or more printing pathways that allow the robot to print each image as single swath in the correct location;
and printing with the printing robot at least a portion of the image swaths while following the printing pathways.

9. The method of claim 8, wherein the printing pathways consist of straight lines at arbitrary angles.

10. The method of claim 9, wherein at least one printing pathway is approximately perpendicular to one other printing pathway.

11. The method of claim 9, wherein the printing pathways additionally include curved paths.

12. The method of claim 8 wherein the method additionally comprises further reducing the total number of printing swaths by omitting portions of the layout elements to be printed, wherein the omitted portions are portions that can be inferred by a viewer of the printed layout.

13. The method of claim 8, wherein one or more annotations (arrows, symbols, labels, geometric patterns, etc.) are added to one or more of the images to provide visual indicators of omitted content.

14. The method of claim 8, further comprising identifying one or more printing pathways that allow more than one swath to be printed along a single pathway.

15. The method of clam 8 wherein the more than one swath is printed by more than one printer.

16. The method of claim 8 wherein the more than one swath is printed sequentially by moving the printhead to a new location to print the next swath.

17. A method comprising:
receiving a list of input shapes of a layout to be printed by a robotic printer, and for each shape:
i. finding the set of all other shapes less than a print head width's distance from it;
ii. finding the set of all other shapes along the same printing path;
iii. combining the two sets into one, and saving the set for that shape;
across all shape sets, merging any two sets that share at least one shape in common;
for each remaining merged shape set:
iv. performing geometry tests on the shapes to determine the number of swaths needed to print the shapes, and the start and end point of each swath;
v. if multiple configurations of swaths are equally capable of printing the shapes, compute a cost score for each configuration;
vi. add the lowest cost configuration to the output list; and
submitting the output list of merged shape sets and their print swaths to the robotic printer.
